(19) United States
(12) Patent Application Publication
(10) Pub. No.: US 2010/0246808 A1
(43) Pub. Date: Sep. 30, 2010

(54) SIDE CHANNEL ATTACK TOLERANCE EVALUATION APPARATUS, METHOD AND PROGRAM

(75) Inventors: Toru Hisakado, Minato-ku (JP); Noritaka Yamashita, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku, Tokyo (JP)

(21) Appl. No.: 12/746,341

(22) PCT Filed: Dec. 4, 2008
(86) PCT No.: PCT/JP2008/072025

§ 371 Date: Jun. 4, 2010

(30) Foreign Application Priority Data
Dec. 5, 2007 (JP) 2007-314670

(51) Int. Cl. G06F 21/00

(52) U.S. Cl. 380/1; 726/25

(57) ABSTRACT

Provided is a side channel attack tolerance evaluation device capable of evaluating the propriety of the estimation of an encryption algorism, processing timing, and determination of a processing sequence of the encryption algorism using side channel information. The side channel attack tolerance evaluation device, which performs evaluation of tolerance to a side channel attack by using side channel information leaking from an encryption device, is provided with a storage unit (character data storage device), a measurement unit (side channel information measurement device), and a processing unit (side channel attack tolerance evaluation unit). The storage unit stores side channel information that has been previously acquired by executing a predetermined encryption algorithm in an encryption device or information obtained by applying predetermined processing to the side channel information. The measurement unit measures the side channel information generated from an encryption device to be evaluated. The processing unit calculates a correlation value between the side channel information acquired by the measurement unit and character data stored in the storage unit to determine the propriety of tolerance of the encryption device to be evaluated to the side channel attack.

### TECHNICAL FIELD

The present invention relates to a side channel attack tolerance evaluation apparatus, method and program, and, more particularly to a side channel attack tolerance evaluation apparatus that determines the propriety of estimation of an implemented encryption algorithm, encryption processing timing, and a processing sequence of the encryption algorithm by using side channel information leaking from an encryption device to evaluate tolerance to a side channel attack.

### BACKGROUND ART

Along with progress of digitization of information, encryption has become an indispensable technique for protection of information and realization of confidential communication. In order to maintain the safety of encryption, it is necessary to prevent confidential information such as an encryption key from being easily estimated. Although there are known cryptanalysis methods, such as a linear cryptanalysis and a differential cryptanalysis, that perform Brute force attack or mathematical decryption, it is impossible to complete the above cryptanalysis within realistic time.

Meanwhile, on the assumption that an attacker can accurately measure side channel information such as processing time and power consumption in an IC (Integrated Circuit) card with encryption function or a device implementing encryption, such as a mobile terminal, a side channel attack that attempts to acquire confidential information from the side channel information and a countermeasure against the side channel attack have become major research themes (refer to, e.g., PTL 1). The side channel information includes information concerning processing or data executed in an encryption device which is a target of attack. Analyzing the side channel information makes it possible to estimate an encryption algorithm, processing timing, and a secret key.

There are known, as a concrete attack method in the side channel attack, timing attack (Refer to NPL 1) made with attention focused on processing time, power analysis made with attention focused on power consumption, electromagnetic wave analysis made with attention focused on a leaking electromagnetic wave, and the like. The power analysis attack includes SPA (Simple Power Analysis) and DPA (Differential Power Analysis) (refer to NPL 2). Non-patent Literature also discloses a concrete method of DPA attack for DES (Data Encryption Standard) which is a known block cipher.

### CITATION LIST

### Patent Literature

{PTL 1} JP-A-2005-20735

### Non-patent Literature

{NPL 1} Paul Kocher, “Timing Attacks on Implementations of Diffie-Hellman, RSA, DSS, and Other Systems”, Crypto' 96, pp. 104-113, 1996.
{NPL 2} P. Kocher, J. Jaffe, B. Jun, “Introduction to Differential Power Analysis and Related Attacks”, 1998.

### SUMMARY OF INVENTION

### Technical Problem

However, there were the following problems in the above related arts.

The encryption algorithm implemented in an encryption device is sometimes brought forward. However, there may be a case where an encryption algorithm implemented for the purpose of further enhancing security is kept confidential. In the case where the algorithm is kept confidential, the implemented encryption algorithm is at risk of being estimated by the side channel attack.

Further, while it is necessary to grasp correct processing timing in an attack using statistical processing, such as DPA, if the processing timing can be estimated from the side channel information, the above attack is made applicable, placing a secret key at risk of being broken.

An object of the present invention is, therefore, to provide a side channel attack tolerance evaluation apparatus capable of evaluating an encryption device to be evaluated in terms of the propriety of estimation of an encryption algorithm, processing timing, and a processing sequence of the encryption algorithm by using the side channel information.

### Solution to Problem

To attain the above object, according to a first aspect of the present invention, there is provided a side channel attack tolerance evaluation apparatus that performs evaluation of tolerance to a side channel attack by using side channel information leaking from an encryption device, comprising: a storage unit that stores as character data the side channel information that has been previously acquired by executing a predetermined encryption algorithm in an encryption device or information obtained by applying predetermined processing to the side channel information; a measurement unit that measures the side channel information generated from an encryption device to be evaluated; and a processing unit that calculates a correlation value between the side channel information acquired by the measurement unit and character data stored in the storage unit to determine the propriety of tolerance of the encryption device to be evaluated to the side channel attack.

According to a second aspect of the present invention, there is provided a side channel attack tolerance evaluation method that performs evaluation of tolerance to a side channel attack by using side channel information leaking from an encryption device, comprising: storing as character data the side channel information that has been previously acquired by executing a predetermined encryption algorithm in an encryption device or information obtained by applying predetermined processing to the side channel information in a storage unit; measuring the side channel information generated from an encryption device to be evaluated; and calculating a correlation between the acquired side channel information and character data stored in the storage unit to determine the propriety of tolerance of the encryption device to be evaluated to the side channel attack.

According to a third aspect of the present invention, there is provided a side channel attack tolerance evaluation program that performs evaluation of tolerance to a side channel attack by using side channel information leaking from an encryption device, allowing a computer to execute: processing of storing as character data the side channel information that has been previously acquired by executing a predetermined encryption algorithm in an encryption device or information obtained by applying predetermined processing to the side channel information in a storage unit; processing of measuring the side channel information generated from an encryption device to be evaluated; and processing of calculating a correlation value between the acquired side channel information and character data stored in the storage unit to determine the propriety of tolerance of the encryption device to be evaluated to the side channel attack.

### ADVANTAGEOUS EFFECTS OF INVENTION

According to the present invention, previously measured character data concerning existing encryption algorisms or processing common to respective encryptions and side channel information measured in an encryption device to be evaluated are compared to determine an encryption algorithm, processing timing, or processing sequence of the encryption algorithm, thereby enabling evaluation of tolerance of the encryption device to a side channel attack.

### BRIEF DESCRIPTION OF DRAWINGS

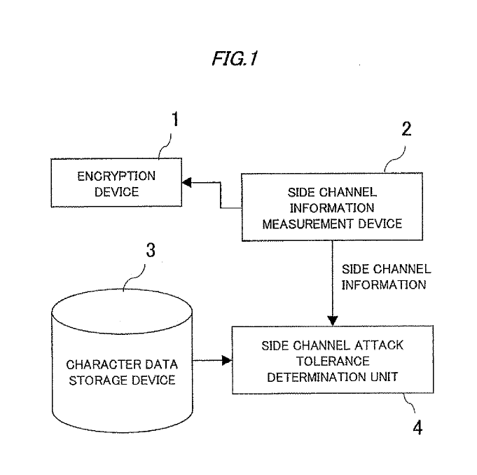

{FIG. 1} A view showing a schematic configuration of a side channel attack tolerance evaluation apparatus according to a first exemplary embodiment of the present invention.

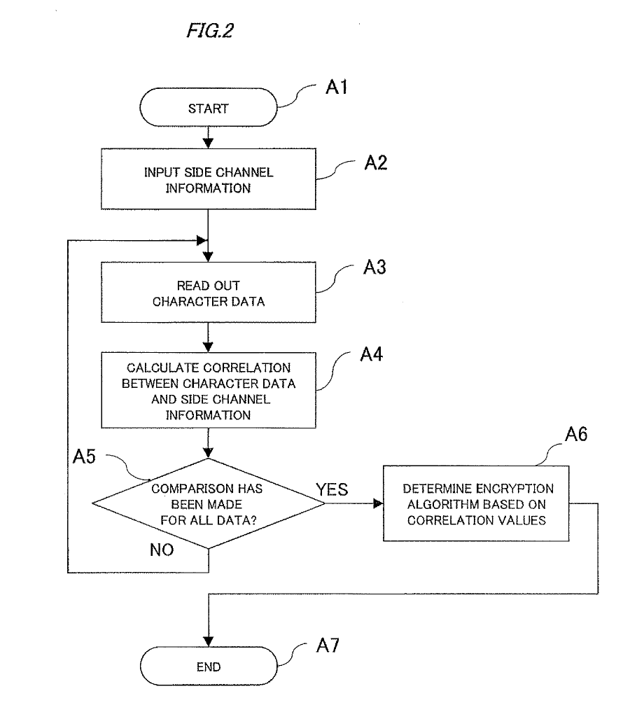

{FIG. 2} A flowchart schematically showing processing performed in a side channel attack tolerance evaluation unit according to the first exemplary embodiment of the present invention.

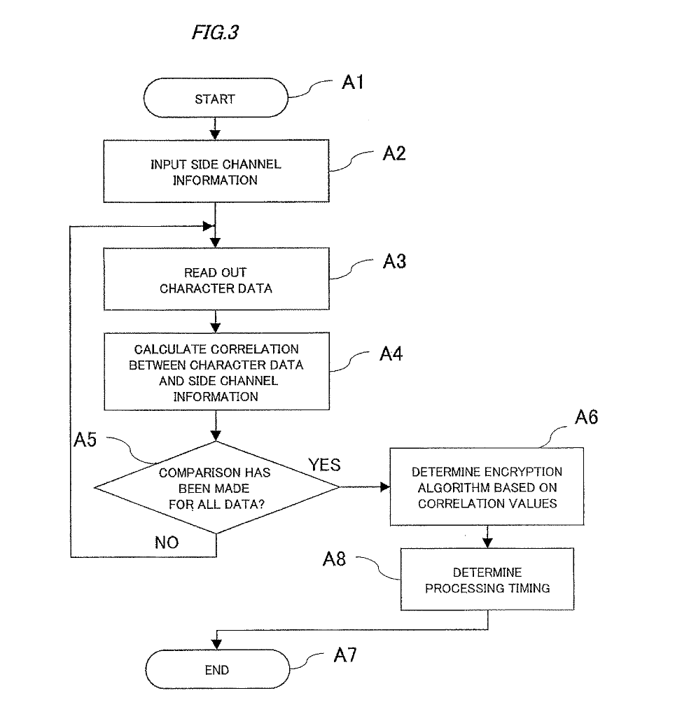

{FIG. 3} A flowchart schematically showing processing performed in the side channel attack tolerance evaluation unit according to a second exemplary embodiment of the present invention.

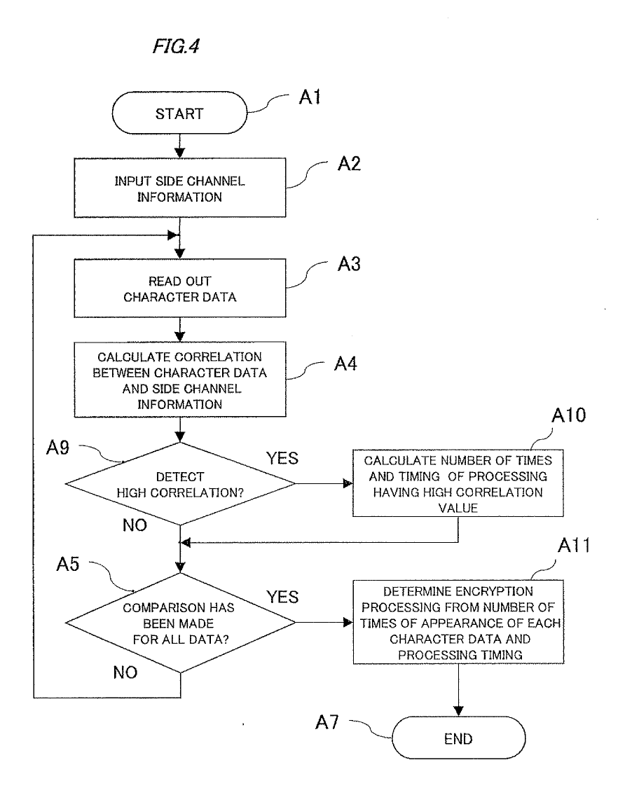

{FIG. 4} A flowchart schematically showing processing performed in the side channel attack tolerance evaluation unit according to a third exemplary embodiment of the present invention.

{FIG. 5} A graph showing the waveform of an electromagnetic wave measured at AES encryption processing time.

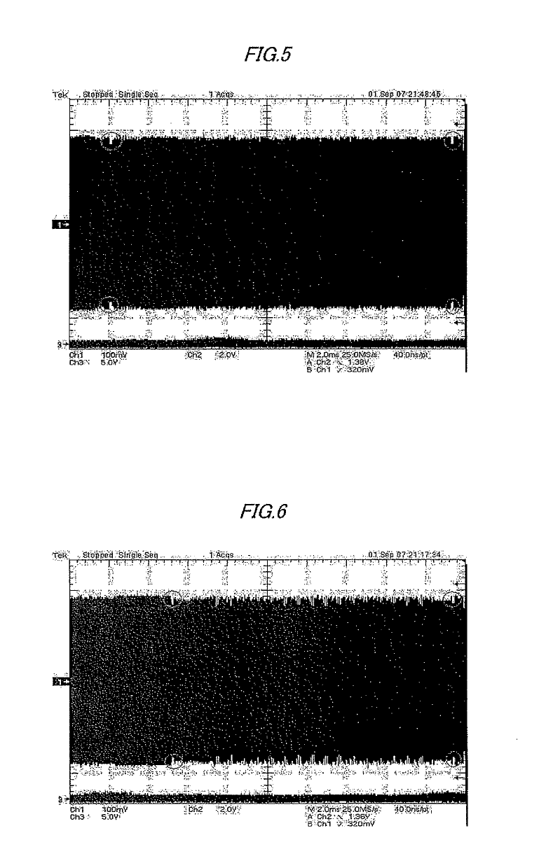

{FIG. 6} A graph showing the waveform of an electromagnetic wave measured at DES encryption processing time.

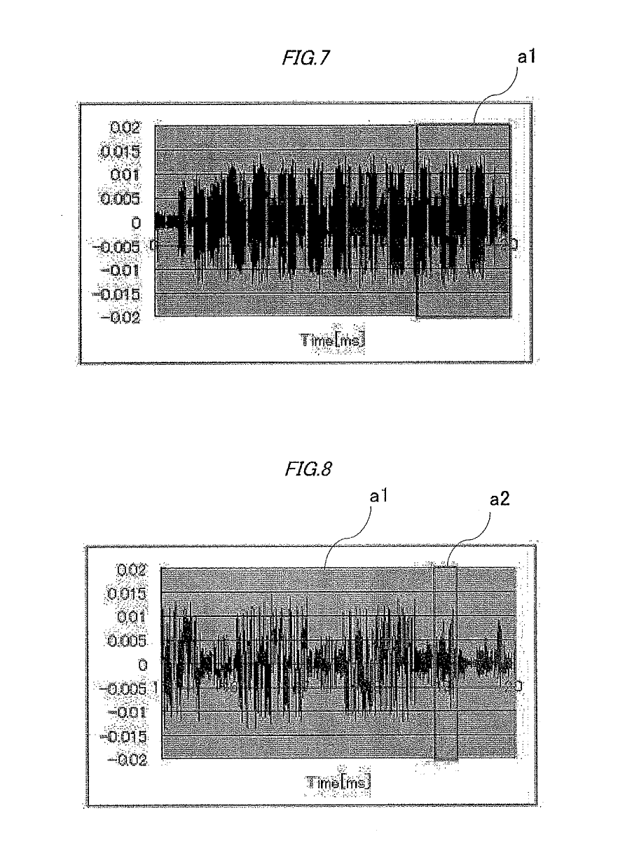

{FIG. 7} A graph showing character data of AES encryption obtained after application of noise removal to the waveform of the electromagnetic wave measured at AES encryption processing time using a band-pass filter.

{FIG. 8} A graph showing character data corresponding to the tenth round of AES encryption.

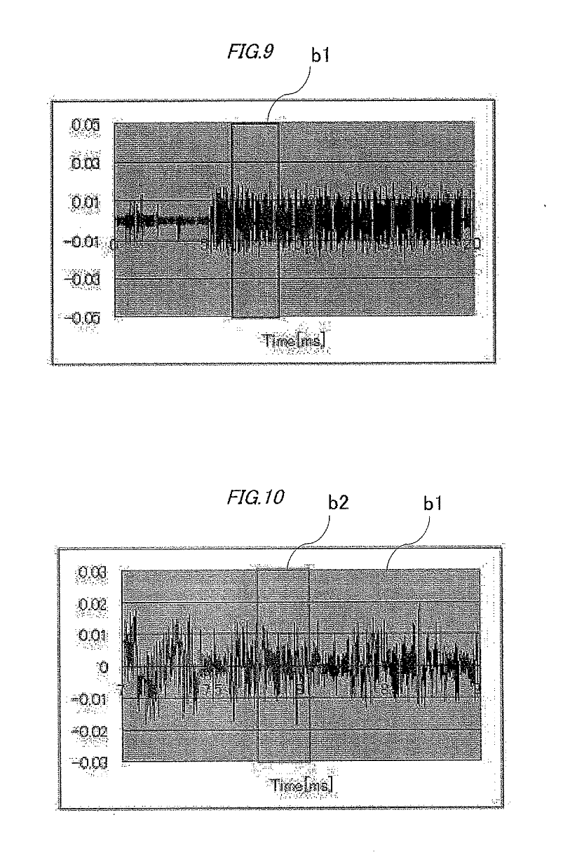

{FIG. 9} A graph showing character data of AES encryption obtained after application of noise removal to the waveform of the electromagnetic wave measured at DES encryption processing time using a band-pass filter.

{FIG. 10} A graph showing character data corresponding to the first round of DES encryption.

{FIG. 11} A graph showing a correlation calculation result between the waveform of an electromagnetic wave measured at AES encryption processing time and character data corresponding to the tenth round of AES encryption.

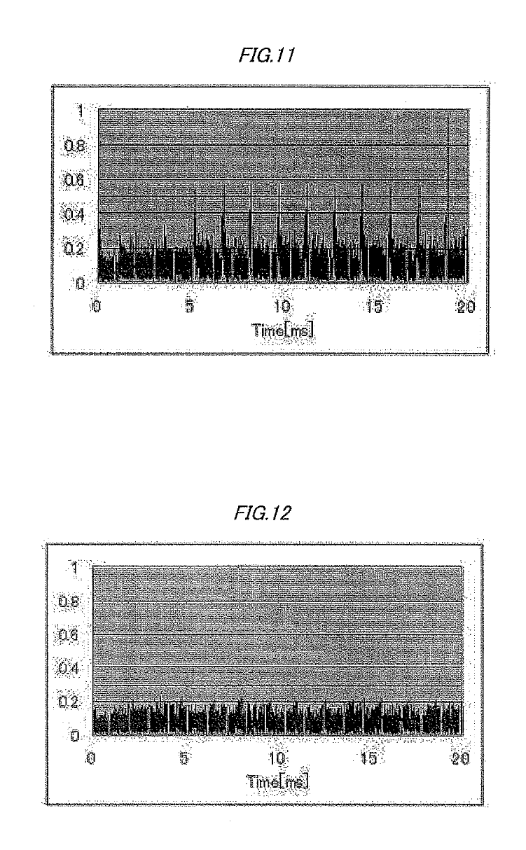

{FIG. 12} A graph showing a correlation calculation result between the waveform of an electromagnetic wave measured at AES encryption processing time and character data corresponding to the first round of DES encryption.

{FIG. 13} A graph showing a correlation calculation result between the waveform of an electromagnetic wave measured at DES encryption processing time and character data corresponding to the tenth round of AES encryption.

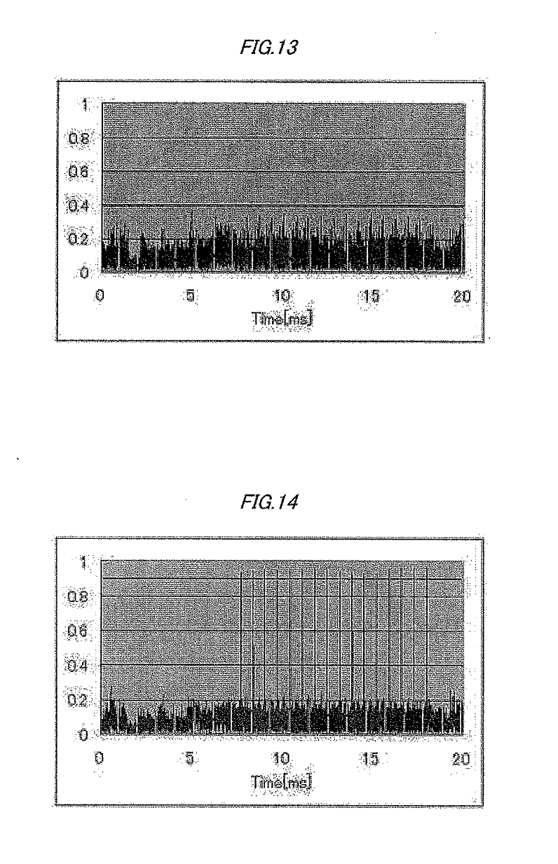

{FIG. 14} A graph showing a correlation calculation result between the waveform of an electromagnetic wave measured at DES encryption processing time and character data corresponding to the first round of DES encryption.

### REFERENCE SIGNS LIST

1: Encryption device
2: Side channel information measurement device (measurement unit)
3: Character data storage device (storage unit)
4: Side channel attack tolerance evaluation unit (processing unit)

### DESCRIPTION OF EMBODIMENTS

Exemplary embodiments of a side channel attack tolerance evaluation apparatus, method, and program according to the present invention will be described in detail with reference to the accompanying drawings.

### First Exemplary Embodiment

A side channel attack tolerance evaluation apparatus according to a first exemplary embodiment of the present invention is designed as a device for evaluating tolerance to the side channel attack that analyzes internal processing of encryption or confidential information by using side channel information leaking from an encryption device and includes a side channel information measurement device (corresponding to a measurement unit of the present invention), a character data storage device (corresponding to a storage unit of the present invention) and a side channel attack tolerance evaluation unit (corresponding to a processing unit of the present invention).

The side channel information measurement device measures side channel information leaking from an encryption device to be evaluated. As the side channel information, various information subject to influence by internal processing, such as power, electromagnetic wave, sound, and temperature may be adopted.

The character data storage device stores character data in the previously acquired side channel information concerning an existing encryption algorithm or processing common to respective encrypted codes.

The side channel attack tolerance evaluation unit uses the characteristics data stored in the character data storage device to compare the side channel information measured by the side channel information measurement device and character data to thereby evaluate the propriety of estimation of an encryption algorithm implemented in an encryption device to be evaluated, processing timing, and an encryption processing sequence.

In the present exemplary embodiment, the side channel attack tolerance evaluation unit may include a unit for calculating a correlation between the side channel information measured in the encryption device to be evaluated and previously acquired character data concerning an existing encryption algorithm and determining an encryption algorithm having a high correlation as an encryption algorithm implemented in the encryption device to be evaluated.

Further, the side channel attack tolerance evaluation unit may include a unit for calculating a correlation between the side channel information measured in the encryption device to be evaluated and previously acquired character data concerning an existing encryption algorithm and determining an encryption algorithm having a high correlation as an encryption algorithm implemented in the encryption device to be evaluated and then determining encryption processing timing from timing having the highest correlation.

Furthermore, the side channel attack tolerance evaluation unit may include a unit for calculating a correlation between the side channel information measured in the encryption device to be evaluated and previously acquired character data concerning processing common to respective encrypted codes to calculate the number of times and timing of the processing having a high correlation with each character data and determining a processing sequence of the encryption algorithm from the number of times of appearance of each character data and processing timing.

FIG. 1 is a view showing a schematic configuration of the side channel attack tolerance evaluation apparatus according to the present exemplary embodiment.

As shown in FIG. 1, the side channel attack tolerance evaluation apparatus includes an encryption device 1 to be evaluated, a side channel information measurement device 2, a characteristics data storage device 3, and a side channel attack tolerance evaluation unit 4.

The encryption device 1 performs encryption/decryption processing of encrypting a plain text and decrypting an encrypted text. As the encryption device 1, various information processors executing encryption/decryption processing may be adopted. For example, a PC (Personal Computer), a mobile terminal, an IC card, a reader/writer, or the like may be adopted.

The side channel information measurement device 2 measures side channel information leaking when the encryption device 1 performs the encryption/decryption processing. As the side channel information, various information subject to influence by internal processing in the encryption device 1 may be adopted. For example, power, electromagnetic wave, sound, temperature, or the like may be adopted. In the case where electromagnetic wave is used as the side channel information, an oscilloscope or a spectrum analyzer may be adopted as the side channel information measurement device 2.

The characteristics data storage device 3 previously stores, as character data, side channel information obtained when the encryption device 1 having the same configuration as an encryption device to be evaluated performs processing common to various encryption algorithms, such as existing algorithms such as DES, AES (Advanced Encryption Standard), or MISTY1, or algorithms mainly adopted in a common key cryptosystem, such as F function, S-box, shift processing. Further, information whose character is clarified by applying signal processing such as band-pass filtering to the side channel information may also be adopted as the character data.

The side channel attack tolerance evaluation unit 4 performs evaluation of tolerance to the side channel attack by comparing the side channel information input from the side channel information measurement device 2 and plurality of character data stored in the characteristics data storage device 3. The side channel attack tolerance evaluation unit 4 has a unit for applying the same signal processing to the side channel information input from the side channel information measurement device 2 and, in the case where data stored in the character data storage device 3 has been subjected to the signal processing.

The hardware and software configurations of the side channel attack tolerance evaluation unit 4 are not particularly limited but any configuration may be adopted as long as it can realize the abovementioned functions. For example, a program (side channel attack tolerance evaluation program) for allowing a computer to realize the above functions can be exemplified.

A person in charge of evaluation operates the side channel attack tolerance evaluation apparatus having the above configuration to extract character data from the previously acquired side channel information concerning a plurality of encryption algorithms and store the extracted characteristics data in the characteristics data storage device 3. After that, encryption processing is executed in the encryption device 1 to be evaluated, and side channel information leaking from the encryption device 1 is measured by the side channel information measurement device 2. The measured side channel information is compared with each character data stored in the characteristics data storage device 3 in the side channel attack tolerance evaluation unit 4, whereby evaluation of tolerance of the encryption device 1 to be evaluated to the side channel attack is made.

Next, with reference to FIG. 2, operation of the present exemplary embodiment will be described.

In the present exemplary embodiment, in evaluating tolerance of the encryption device 1 to be evaluated to the side channel attack, the side channel attack tolerance evaluation unit 4 calculates a correlation between the side channel information measured using the encryption device 1 to be evaluated and previously acquired side channel data concerning an existing encryption algorithm and determines an encryption algorithm having a highest correlation as the encryption algorithm implemented in the encryption device 1 to be evaluated.

FIG. 2 is a flowchart showing processing performed in the side channel attack tolerance evaluation unit 4 in the present exemplary embodiment.

When determination processing is started (step A1), side channel information is input (step A2). After completion of the input of the side channel information, character data concerning an encryption algorithm is read out from the characteristics data storage device 3 (step A3). After completion of the readout of the character data, a correlation between the character data and input side channel information is calculated (step A4).

The processing of steps A3 and A4 are repeated until comparison is done for all data (NO in step A5). At the time point when comparison has been made for all character data concerning the encryption algorithm stored in the characteristics data storage device 3 (YES in step A5), an encryption algorithm having the highest correlation of all the calculated correlation values is determined as an encryption algorithm implemented in the encryption device 1 to be evaluated (step A6), and this determination processing is ended (step A7).

If the determined algorithm is the algorithm actually implemented in the encryption device 1 to be evaluated, it is evaluated that the encryption device 1 to be evaluated does not have tolerance to the side channel attack. On the other hand, if the determined algorithm differs from the implemented algorithm, it is evaluated that the encryption device 1 to be evaluated has tolerance to the side channel attack.

In the case where the measurement data includes a lot of noise, signal processing is applied after input of the side channel information to thereby improve the accuracy of the side channel attack tolerance evaluation apparatus. In this case, it is necessary for the character data to have been subjected to the similar signal processing.

### Second Exemplary Embodiment

Next, a second exemplary embodiment of the present invention will be described with reference to FIG. 3. A schematic configuration of a side channel attack tolerance evaluation apparatus according to the present exemplary embodiment is the same as that of the first exemplary embodiment shown in FIG. 1. The same reference numerals as those in the first exemplary embodiment denote the same or corresponding parts as those in the first exemplary embodiment, and the descriptions thereof will be simplified or omitted. In the following, operation of the present exemplary embodiment will be described.

In the present exemplary embodiment, in evaluating tolerance of the encryption device 1 to be evaluated to the side channel attack, the side channel attack tolerance evaluation unit 4 calculates a correlation between the side channel information measured using the encryption device 1 to be evaluated and previously acquired side channel data concerning an existing encryption algorithm, determines an encryption algorithm having a highest correlation as the encryption algorithm implemented in the encryption device 1 to be evaluated, and determines encryption processing timing from the above determination result.

FIG. 3 is a flowchart showing processing performed in the side channel attack tolerance evaluation unit 4 in the present exemplary embodiment. The flowchart of FIG. 3 differs from the flowchart of FIG. 2 in that after step A6 in which determination of the encryption algorithm is made, determination (step A8) of processing timing is made based on the correlation value of the algorithm.

If the determined encryption processing timing is the encryption processing timing in the encryption device 1 to be evaluated, it is evaluated that the encryption device 1 to be evaluated does not have tolerance to the side channel attack. On the other hand, if the determined encryption processing timing differs from the encryption processing timing in the encryption device 1 to be evaluated, it is evaluated that the encryption device 1 to be evaluated has tolerance to the side channel attack.

In the case where the measurement data includes a lot of noise, signal processing is applied after input of the side channel information to thereby improve the accuracy of the side channel attack tolerance evaluation apparatus. In this case, it is necessary for the character data to have been subjected to the similar signal processing.

### Third Exemplary Embodiment

Next, a third exemplary embodiment of the present invention will be described with reference to FIG. 4. A schematic configuration of a side channel attack tolerance evaluation apparatus according to the present exemplary embodiment is the same as that of the first exemplary embodiment shown in FIG. 1. The same reference numerals as those in the first exemplary embodiment denote the same or corresponding parts as those in the first exemplary embodiment, and the descriptions thereof will be simplified or omitted. In the following, operation of the present exemplary embodiment will be described.

In the present exemplary embodiment, in evaluating tolerance of the encryption device 1 to be evaluated to the side channel attack, the side channel attack tolerance evaluation unit 4 calculates a correlation between the side channel information measured using the encryption device 1 to be evaluated and previously acquired side channel data concerning an existing encryption algorithm, determines an encryption algorithm having a highest correlation as the encryption algorithm implemented in the encryption device 1 to be evaluated, and determines encryption processing timing from the above determination result.

FIG. 4 is a flowchart showing processing performed in the side channel attack tolerance evaluation unit 4 in the present exemplary embodiment. The flowchart of FIG. 4 differs from the flowchart of FIG. 2 in that when a high correlation is detected (step A9), the number of times and timing of processing is calculated (step A10) and that an encryption processing sequence is determined from the number of times of appearance of each character data and processing timing (step A11).

If the determined encryption processing sequence is the encryption processing sequence implemented in the encryption device 1 to be evaluated, it is evaluated that the encryption device 1 to be evaluated does not have tolerance to the side channel attack. On the other hand, if the determined encryption processing sequence differs from the encryption processing sequence implemented in the encryption device 1 to be evaluated, it is evaluated that the encryption device 1 to be evaluated has tolerance to the side channel attack.

In the case where the measurement data includes a lot of noise, signal processing is applied after input of the side channel information to thereby improve the accuracy of the side channel attack tolerance evaluation apparatus. In this case, it is necessary for the character data to have been subjected to the similar signal processing.

### Example 1

Next, with reference to FIGS. 5 to 14, Example 1 of the present invention will be described.

In the present example, side channel attack tolerance was evaluated in the abovementioned first exemplary embodiment. More specifically, AES and DES were implemented as encryption algorithm executed by an evaluation board as the encryption device 1 that can execute encryption processing, an oscilloscope was used as the side channel information measurement device 2 to measure electromagnetic waves as the side channel information leaking from the evaluation board that was processing the AES and DES, and the side channel attack tolerance was evaluated using the measured electromagnetic waves.

The AES and DES were implemented in the evaluation board in order to extract the character data, and an oscilloscope was used to measure electromagnetic waves leaking from the evaluation board that was performing AES encryption processing and DES encryption processing (see FIGS. 5 and 6).

Subsequently, band-pass filtering was applied to the waveform (FIG. 5) of the measured electromagnetic wave measured at the AES encryption processing time so as to remove noise. Waveform data as the character data of the AES encryption that has been subjected to the noise removal is shown in FIG. 7. Further, waveform data obtained by enlarging a part surrounded by a frame a1 in FIG. 7 is shown in FIG. 8. The part surrounded by a frame a2 in FIG. 8 denotes the tenth round of the AES encryption processing consisting of ten rounds to be executed. The waveform data was stored in the character data storage device 3 as the character data of the AES.

Further, band-pass filtering was applied to the waveform (FIG. 6) of the measured electromagnetic wave measured at the DES encryption processing time so as to remove noise. Waveform data as the character data of the DES encryption that has been subjected to the noise removal is shown in FIG. 9. Further, waveform data obtained by enlarging a part surrounded by a frame b1 in FIG. 9 is shown in FIG. 10. The part surrounded by a frame b2 in FIG. 10 denotes the first round of the DES encryption processing consisting of sixteen rounds to be executed. The waveform data was stored in the character data storage device 3 as the character data of the DES.

Then, in order to evaluate a case where the AES is implemented as the encryption algorithm executed by the evaluation board as the encryption device 1 to be evaluated, the AES encryption processing was executed once again by the evaluation board, and an electromagnetic wave from the evaluation board was measured as the side channel information leaking from the encryption device 1. The similar waveform of the measured electromagnetic wave to that of FIG. 5 was acquired by the measurement, and acquired waveform data was input to the side channel attack tolerance evaluation unit 4 (step A2). The side channel attack tolerance evaluation unit 4 applied band-pass filtering to the input waveform of the electromagnetic wave so as to remove noise.

Subsequently, the character data of the AES was read out from the character data storage device 3 (step A3), and a correlation between the waveform data obtained after the band-pass filtering and read out character data of the AES was calculated (step A4). The calculation result is shown in FIG. 11.

Subsequently, the character data of the DES was read out from the character data storage device 3 (step A3), and a correlation between the waveform obtained after the band-pass filtering and read out character data of the AES was calculated (step A4). The calculation result is shown in FIG. 12.

After completion of the correlation calculations with respect to the two character data (YES in step A5), an algorithm having a higher correlation was determined based on the calculated correlation values (step A6). That is, as is clear from FIGS. 11 and 12, the acquired waveform data has a high correlation with the AES character data. Thus, the AES was determined as the implemented encryption algorithm.

Then, in order to evaluate a case where the DES is implemented as the encryption algorithm executed by the evaluation board as the encryption device 1 to be evaluated, the same processing as above was executed. As a result, FIG. 13 was obtained as a correlation calculation result between the waveform data and AES character data, and FIG. 14 was obtained as a correlation calculation result between the waveform data and DES character data. As is clear from FIGS. 13 and 14, the waveform data has a high correlation with the DES character data. Thus, the DES was determined as the implemented encryption algorithm.

### Example 2

Next, Example 2 of the present invention will be described.

In the present example, side channel attack tolerance was evaluated in the abovementioned second exemplary embodiment as in the case of Example 1. Example 2 differs from Example 1 in that after step A6 in which determination of the encryption algorithm is made, determination (step A8) of processing timing is made based on the correlation value of the algorithm.

As a result, in the determination of the processing timing in the AES encryption processing, ten high correlations were confirmed from FIG. 10. The AES is an encryption algorithm executing processing consisting of ten rounds and, it was determined that the respective rounds were executed at the ten timings each exhibiting a high correlation.

Similarly, in the DES encryption processing, 16 high correlations were confirmed from FIG. 14. The DES is an encryption algorithm executing processing consisting of 16 rounds and, it was determined that the respective rounds were executed at the 16 timings each exhibiting a high correlation.

The physical configuration of the side channel attack tolerance evaluation apparatus according to each of the above embodiments and hardware (circuit) and software (program) configuration provided in the apparatus are not especially limited as long as they can realize respective processing (functions) of the above components (side channel information measurement device (measurement unit), character data storage device (storage unit), and side channel attack tolerance evaluation unit (processing unit)). For example, a configuration in which each component constitutes an individual circuit, unit, or a program part (program module, etc.), or a configuration in which all the components are integrated in a single circuit or unit may be adopted. The abovementioned configurations may appropriately be selected, modified, and deformed depending on a factor such as the function or use purpose of an apparatus to be actually used.

Further, a side channel attack tolerance evaluation method having processing steps that executes the same processing as those of the respective functions corresponding to the above components is also included in the category of the present invention.

Further, at least a part of processing of the functions of the above components may be realized by software processing performed by a computer constituted by a microprocessor having a CPU (Central Processing Unit). In this case, a program for allowing the computer to function is included in the category of the present invention.

The program includes, not only a program that can directly be executed by the CPU, but also various types of programs such as a source code program, a compressed program, and encrypted program. The program may be of any type such as an application program that operates in cooperation with a control program for controlling the entire operation of the apparatus, such as an OS (operating System) or firmware or that is integrated in a part of the control program to operate integrally therewith or a software part (software module) that constitutes the application program. Further, in the case where the program is implemented in an apparatus having a communication function of communicating with an external apparatus via wired or wireless connection, the program may be downloaded from an external node such as a server or the like on a network to be installed in a recording medium of the apparatus. The abovementioned configurations may appropriately be selected, modified, and deformed depending on a factor such as the function or use purpose of an apparatus to be actually used.

Further, a computer-readable recording medium that stores the above program is included in the category of the present invention. In this case, the recording medium may be of any type such as a fixed type such as an ROM (Read Only Memory) that is fixed in an apparatus or portable type that can carried by a user.

The processing unit of the present invention corresponding to the side channel attack tolerance evaluation unit may determine the encryption algorithm executed in the encryption device to be evaluated. Further, the processing unit of the present invention may specify the processing timing of the encryption processing executed in the encryption device to be evaluated. Further, the processing unit of the present invention may calculate the number of times of appearance and processing timing of character data exhibiting a high correlation value with the side channel information in the processing of calculating a correlation value between the side channel information acquired from the measurement unit and character data stored in the storage unit and determine a processing sequence of the encryption algorithm from the number of times of appearance and processing timing of the character data.

Although the present invention has been described in detail with reference to the above exemplary embodiments and examples, it should be understood that the present invention is not limited to the above exemplary embodiments and examples. Various changes that those skilled in the art can understand can be made to the configuration and details of the present invention without departing from the sprit and scope of the invention.

This application is based upon and claims the benefit of priority from Japanese patent application No. 2007-314670, filed on Dec. 5, 2007, the disclosure of which is incorporated herein in its entirety by reference.

### INDUSTRIAL APPLICABILITY

The present invention can be applied to a side channel attack tolerance evaluation apparatus, method, and program that determine the propriety of estimation of an implemented encryption algorithm, encryption processing timing, and a processing sequence of the encryption algorithm by using side channel information leaking from an encryption device to evaluate tolerance to a side channel attack.

1. A side channel attack tolerance evaluation apparatus that performs evaluation of tolerance to a side channel attack by using side channel information leaking from an encryption device, comprising:
a storage unit that stores, as character data representing the type of an encryption algorithm, the side channel information that has been previously acquired by executing a predetermined encryption algorithm in an encryption device or information obtained by applying predetermined processing to the side channel information;
a measurement unit that measures the side channel information generated from an encryption device to be evaluated; and
a processing unit that calculates a correlation value between the side channel information acquired by the measurement unit and character data stored in the storage unit and determines the encryption algorithm executed in the encryption device to be evaluated to thereby determine the propriety of tolerance of the encryption device to be evaluated to the side channel attack.

2. (canceled)

3. A side channel attack tolerance evaluation apparatus that performs evaluation of tolerance to a side channel attack by using side channel information leaking from an encryption device, comprising:
a storage unit that stores, as character data representing round processing, the side channel information that has been previously acquired by executing a predetermined encryption algorithm in an encryption device or information obtained by applying predetermined processing to the side channel information;
a measurement unit that measures the side channel information generated from an encryption device to be evaluated; and
a processing unit that calculates a correlation value between the side channel information acquired by the measurement unit and character data representing round processing stored in the storage unit and determines the processing timing of the round processing executed in the encryption device to be evaluated to thereby determine the propriety of tolerance of the encryption device to be evaluated to the side channel attack.

4. The side channel attack tolerance evaluation apparatus according to claim 1, wherein
the processing unit calculates the number of times of appearance and processing timing of the character data of the round processing exhibiting a high correlation with the side channel information in the processing of calculating a correlation value between the side channel information acquired from the measurement unit and character data representing round processing stored in the storage unit and specifies a processing sequence of the encryption algorithm from the number of times of appearance and processing timing of the character data.

5. The side channel attack tolerance evaluation apparatus according to claim 1, wherein
the predetermined encryption algorithm includes DES (Data Encryption Standard) and AES (Advanced Encryption Standard), and
the side channel information includes waveform data of electromagnetic waves respectively leaking at the time when the DES encryption and AES encryption are processed in the encryption device.

6. A side channel attack tolerance evaluation method that performs evaluation of tolerance to a side channel attack by using side channel information leaking from an encryption device, comprising:
storing, as character data representing the type of an encryption algorithm, the side channel information that has been previously acquired by executing a predetermined encryption algorithm in an encryption device or information obtained by applying predetermined processing to the side channel information in a storage unit;
measuring the side channel information generated from an encryption device to be evaluated; and
calculating a correlation value between the acquired side channel information and character data stored in the storage unit and determining the encryption algorithm executed in the encryption device to be evaluated to thereby determine the propriety of tolerance of the encryption device to be evaluated to the side channel attack.

7. A computer-readable medium stored therein a side channel attack tolerance evaluation program that performs evaluation of tolerance to a side channel attack by using side channel information leaking from an encryption device, allowing a computer to execute:
processing of storing, as character data representing the type of an encryption algorithm, the side channel information that has been previously acquired by executing a predetermined encryption algorithm in an encryption device or information obtained by applying predetermined processing to the side channel information in a storage unit;
processing of measuring the side channel information generated from an encryption device to be evaluated; and
processing of calculating a correlation value between the acquired side channel information and character data stored in the storage unit and determining the encryption algorithm executed in the encryption device to be evaluated to thereby determine the propriety of tolerance of the encryption device to be evaluated to the side channel attack.

8. A side channel attack tolerance evaluation method that performs evaluation of tolerance to a side channel attack by using side channel information leaking from an encryption device, comprising:
storing, as character data representing round processing, the side channel information that has been previously acquired by executing a predetermined encryption algorithm in an encryption device or information obtained by applying predetermined processing to the side channel information in a storage unit;
measuring the side channel information generated from an encryption device to be evaluated; and
calculating a correlation value between the side channel information acquired and character data representing round processing stored in the storage unit and determines the processing timing of the round processing executed in the encryption device to be evaluated to thereby determine the propriety of tolerance of the encryption device to be evaluated to the side channel attack.

9. A computer-readable medium stored therein a side channel attack tolerance evaluation program that performs evaluation of tolerance to a side channel attack by using side channel information leaking from an encryption device, allowing a computer to execute:
processing of storing, as character data representing round processing, the side channel information that has been previously acquired by executing a predetermined encryption algorithm in an encryption device or information obtained by applying predetermined processing to the side channel information;
processing of measuring the side channel information generated from an encryption device to be evaluated; and
calculating a correlation value between the side channel information acquired by the measurement unit and character data representing round processing stored in the storage unit and determines the processing timing of the round processing executed in the encryption device to be evaluated to thereby determine the propriety of tolerance of the encryption device to be evaluated to the side channel attack.
